(19) United States
(12) Patent Application Publication
(10) Pub. No.: US 2019/0132518 A1
(43) Pub. Date: May 2, 2019

(54) IMAGE PROCESSING APPARATUS, IMAGING APPARATUS AND CONTROL METHOD THEREOF

(71) Applicant: CANON KABUSHIKI KAISHA, Tokyo (JP)

(72) Inventor: Takashi Kon, Yokohama-shi (JP)

(21) Appl. No.: 16/158,463

(22) Filed: Oct. 12, 2018

(30) Foreign Application Priority Data
Oct. 27, 2017 (JP) 2017-208405

(51) Int. Cl. H04N 5/232; G06T 5/00; G06T 5/50; G06T 7/20

(52) U.S. Cl. CPC H04N 5/23267; G06T 5/003; G06T 5/50; G06T 2207/20201; H04N 5/23254; G06T 2207/20221; G06T 2207/10016; G06T 7/20

(57) ABSTRACT

An image processing apparatus obtains a short exposure image and a long exposure image. The image processing apparatus detects motion vectors based on the short exposure image and detects a main object area based on the long exposure image. The image processing apparatus further determines, among the vectors, a motion vector corresponding to the main object area, as a motion vector of a main object.

### BACKGROUND OF THE INVENTION

### Field of the Invention

The present invention relates to an image processing apparatus, imaging apparatus, and a control method thereof.

### Description of the Related Art

Image processing apparatuses have been proposed for correcting an image blur or for synthesizing images using vector information, which is detected based on amount of movement of an object between successively obtained frame images. However, if the vector information of a main object is erroneously detected by image processing apparatuses when plural objects exist within a same field of view while detecting vectors, the blur is over corrected or synthesizing images fails.

Japanese Patent Laid-Open No. 2016-171541 discloses an apparatus that generates a histogram based on vectors obtained from a plurality of areas within one frame image, and then detects a vector larger than a predetermined threshold level as a vector of a main object. However, the apparatus disclosed in the above document presumes that a vector larger than the predetermined threshold level as the vector of a main object, and if plural objects exist in the same field of view, the vector of a main object will be mistakenly determined depending on a setting of the threshold level. In addition, the apparatus disclosed in the above document loses the location information for each vector because it merely produces the histogram based on vectors detected from a plurality of areas within one frame image.

### SUMMARY OF THE INVENTION

The present invention provides an image processing apparatus that can accurately detect a motion vector of a main object even when a plurality of objects exist in a same field angle.

An image processing apparatus according to the present invention is provided that includes: at least one processor and at least one memory functioning as: an obtaining unit configured to obtain a first image corresponding to a first exposure period and a second image corresponding to a second exposure period longer than the first exposure period; a first detection unit configured to detect a motion vector based on the first image; a second detection unit configured to detect a main object area based on the second image; and a control unit configured to determine a motion vector corresponding to the main object area detected by the second detection unit as a motion vector of a main object, among the vectors detected by the first detection unit.

According to the present invention, it is possible to accurately detect a motion vector of a main object even when a plurality of objects exist in a same field angle.

Further features of the present invention will become apparent from the following description of exemplary embodiments (with reference to the attached drawings).

### BRIEF DESCRIPTION OF THE DRAWINGS

FIG. 1 is a schematic block diagram illustrating an image processing apparatus according to an embodiment.

FIG. 2 is a schematic block diagram illustrating an imaging apparatus according to an embodiment.

FIG. 3 is a diagram illustrating detecting vectors of a main object.

FIG. 4 is a flowchart illustrating detecting vectors of a main object.

FIG. 5 is a flowchart illustrating generating an object mask.

FIG. 6 is a diagram illustrating another example of detecting vectors of a main object.

### DESCRIPTION OF THE EMBODIMENTS

### First Embodiment

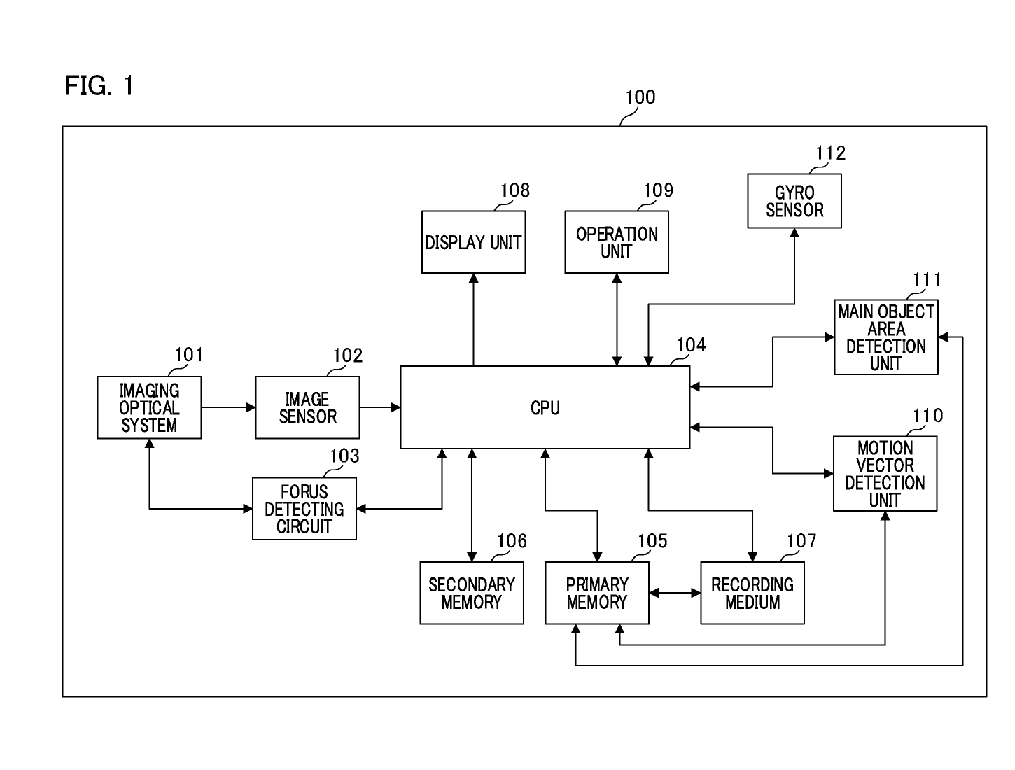

FIG. 1 is a schematic block diagram of an image processing apparatus according to the present embodiment. In FIG. 1, an imaging apparatus 100 will be described as an example of an image processing apparatus. The imaging apparatus 100 may be a camera such as a digital camera or a digital video camera, or any type of an electronic apparatus having a camera function such as a cell phone having camera function or a computer having a camera.

The imaging apparatus 100 shown in FIG. 1 has an imaging optical system 101 and a gyro sensor 112. The imaging optical system 101 and the gyro sensor 112 may be equipped in an exchangeable lens unit that is attachable to the imaging apparatus 100. The imaging optical system 101 focuses an object image on an image sensor 102 under a control of a CPU 104. The imaging optical system includes lenses, a shutter and an iris. The image sensor 102, which is for example a CCD (Charge Coupled Device) image sensor or a CMOS (Complementary Metal Oxide Semiconductor) image sensor, converts the object image focused by the optical system 101 into an image signal. A focus detecting circuit 103 performs focus detection process (AF) using for example a phase difference detection method.

The CPU 104, serving as a control unit, controls various functions of the image processing apparatus of the present embodiment. Concretely, the CPU 104 controls various parts of the imaging apparatus 100 according to a (computer) program stored in a memory or a control signal input from an outside of the imaging apparatus. A primary memory 105, which is a volatile memory such as a RAM (Random Access Memory), stores temporary data and is used as a working space for the CPU 104. The information stored in the primary memory 105 is used by a motion vector detection unit 110 or a main object area detection unit 111. The information stored in the primary memory 105 is possibly recorded in a recording medium 107. A secondary memory 106 is an involatile memory such as an EEPROM (Electrically Erasable Programmable Read Only Memory) and stores a computer program (firmware) for controlling the imaging apparatus 100 and a variety setting information which is used by the CPU 104.

The recording medium 107 stores data such as image data that has been obtained by an image shooting operation and was temporarily stored in the primary memory 105. The recording medium 107 is detachable from the imaging apparatus 100 and may be a semiconductor memory card. The recording medium 107 can be inserted into a PC so that data stored in the recording medium 107 can be read out by the PC. The imaging apparatus 100 has a mechanism for attaching/detaching the recording medium 107, and also has writing/reading function to/from the recording medium 107.

A display unit 108 displays various images such as a view-finder image during an image shooting operation, an image recorded as a result of the image shooting operation, or a GUI (Graphical User Interface) image for dialogical operation. An operation unit 109 includes a group of input devices that receive a user operation and transmit the input information to the CPU 104. The display unit 108 may include buttons, levers, a touch panel, or input devices that use voice or a line of sight. A motion vector detection unit 110 detects a motion vector using a captured image. The main object area detection unit 111 detects a main object area from the captured image. The gyro sensor 112 detects a shake applied to the camera. Therefore, a panning operation of the camera and the like is detected.

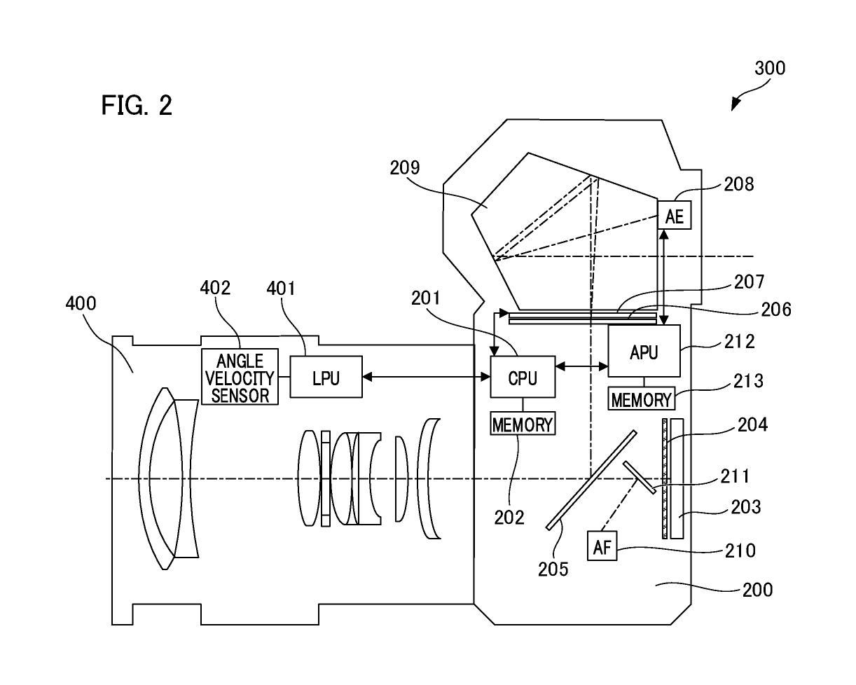

FIG. 2 is a schematic block diagram of the imaging apparatus. The imaging apparatus 300 shown in FIG. 2 corresponds to the imaging apparatus 100 shown FIG. 1 and has functions corresponding to those of the units shown in FIG. 1. The imaging apparatus 300 has a camera body 200 and a lens unit 400.

The camera body includes a CPU (Central Processing Unit) 201 and a memory 213. The CPU 201 controls the entire imaging apparatus 300. The memory 202 is a memory unit, such as a RAM (Random Access Memory) and a ROM (Read Only Memory), connected to the CPU 201.

The image sensor 203 corresponds to the image sensor 102 shown in FIG. 1. A shutter 204 shields the image sensor 203 at the time of non-shooting and opens to guide light ray to the image sensor 203 at the time of shooting. A half-mirror 205 reflects a part of light passing through the lens 400 at the time of non-shooting to focus on a pint glass 206. A display device 207, which includes a PN liquid crystal and the like, displays a AF (Auto Focusing) distance measuring point. A user can see which point is being used for a focus detection process while viewing an optical finder.

A photometric sensor (AE) 208 measures a light amount. A pentaprism 209 guides an object image of the pint glass 206 to the photometric sensor 208 and the optical finder. The Photometric sensor 208 monitors, from an oblique position through the pentaprism 209, the object image focused on the pint glass 206. A focus detecting circuit (an AF circuit) 210 receives a part of the light, which is passed through the lens and the half-mirror 205 and thereafter is guided by an AF mirror 211 to an AF sensor, and performs focus detection operation. An APU 212 is another CPU especially used for image processing and calculation for the Photometric sensor 208.

A memory 213 is a memory unit, such as a RAM or ROM, and is connected to the APU 212. In the embodiment shown in FIG. 2, although the imaging apparatus 300 has the APU 212, which is an additional CPU especially used for the photometric sensor, the imaging apparatus 300 may perform the function of APU 212 by using the CPU 201, which functions as a camera microcomputer. In addition, the motion vector detection unit 110 and the main object area detection unit 111 in FIG. 1 may be included either in the CPU 201 or not included in the APU 212.

The lens unit 400 includes an LPU 401 and an angle velocity sensor 402. The LPU 401 is a CPU functioning serving as a lens microcomputer. The LPU 401 transmits information of a distance to an object and information of an angle velocity, to the CPU 201. The angle velocity sensor 402 detects an angle velocity indicating a shake applied to the lens unit 400 and converts the angle velocity information (shake detection signal) as an electric signal to transmit to the LPU 401. The angle velocity sensor 402 is for example a gyro sensor. The LPU 401 drives a shift lens (not shown) based on an angle velocity corresponding to a vector of a main object and an output of the angle velocity sensor 402, so that an image blur of the object is corrected.

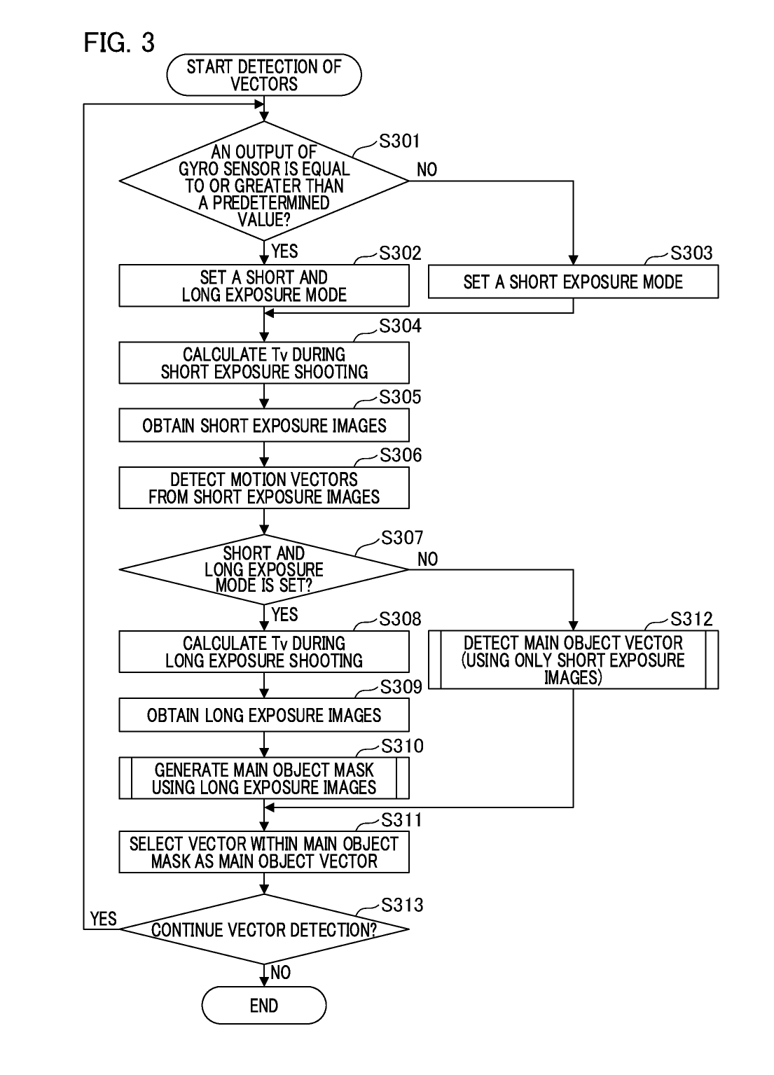

FIG. 3 is a flowchart illustrating detection of the vector of a main object by the image processing apparatus of the first embodiment. In step S301, the CPU 201 determines whether or not a user is panning the camera based on an output of the gyro sensor 112 or an output of the angle velocity sensor 402. To be more specific, the CPU 201 determines whether or not the output of the gyro sensor 112 or the output of the angle velocity sensor 402 is equal to or greater than a predetermined value (a threshold value). If the output of the gyro sensor 112 and the output of the angle velocity sensor 402 are not equal to or greater than the threshold value, the CPU 201 determines that the user is not panning the camera and the process proceeds to step S303. In step S303, the CPU 201 sets an operation mode of the imaging apparatus 300 to a short exposure mode (a first mode) for performing a vector detection from an image shot with short-second exposure (a short exposure image) Here, the short exposure image is a first image corresponding to a first exposure period. When the user is not panning the camera, since there is no large difference in the motion vector obtained from the image imaged according to the length of the exposure period, the imaging apparatus 300 detects the motion vector using only the short exposure image so as to prevent a shake caused by camera vibration or a movement of an object.

In step S301, if the output of the gyro sensor 112 or the output of the angle velocity sensor 402 are equal to or greater than the threshold value, the CPU 201 determines that the user is panning the camera, and the process proceeds to step S302. In step S302, the CPU 201 sets an operation mode of the imaging apparatus 300 to a short and long exposure mode (a second mode) for capturing both a short exposure image and a long exposure image. Here, the long exposure image is an image shot with long exposure, that is, a second image corresponding to a second exposure period which is longer than the first exposure period.

In step S304, the CPU 201 calculates the first exposure period (Tv [sec]) used for obtaining (imaging) the short exposure image using the following formula (1).

$$Tv [ sec ] = \frac{α}{f [ mm ] \times ω [ deg \text{/} sec ]} \qquad ( 1 )$$

Wherein, “f′ is a focus distance [mm] of a photo-taking lens, “α” is an arbitrary value, “ω” is an angle velocity [deg/sec] of the camera at the time of panning. By changing the value “α”, the short exposure period and the long exposure period can be calculated. The CPU 201 may changes the first exposure period based on an amount of the output of the gyro sensor 112 or the angle velocity sensor 402 without using the formula (1). For example, the more the CPU 201 shortens the first exposure period as the output of the gyro sensor 112 or the angle velocity sensor 402 increase.

Next, in step S305, the CPU 201 obtains the short exposure image based on the Tv set in step S304. Then, in step S306, the CPU 201 functions as a first detecting unit and detects the motion vector using the short exposure image obtained in step S305. Here, the detection of the motion vectors may be performed using a template matching method or a background difference method, and the like.

Next, in step S307, the CPU 201 determines whether or not the second mode (the short and long exposure mode) is set. If the short and long exposure mode is set, the process proceeds to step S308. If the first mode (the short exposure mode) is set instead of the short and long exposure mode, the process proceeds to step S312. In the step S312, the CPU201 detects a vector of a main object based on only vector data obtained in step S306.

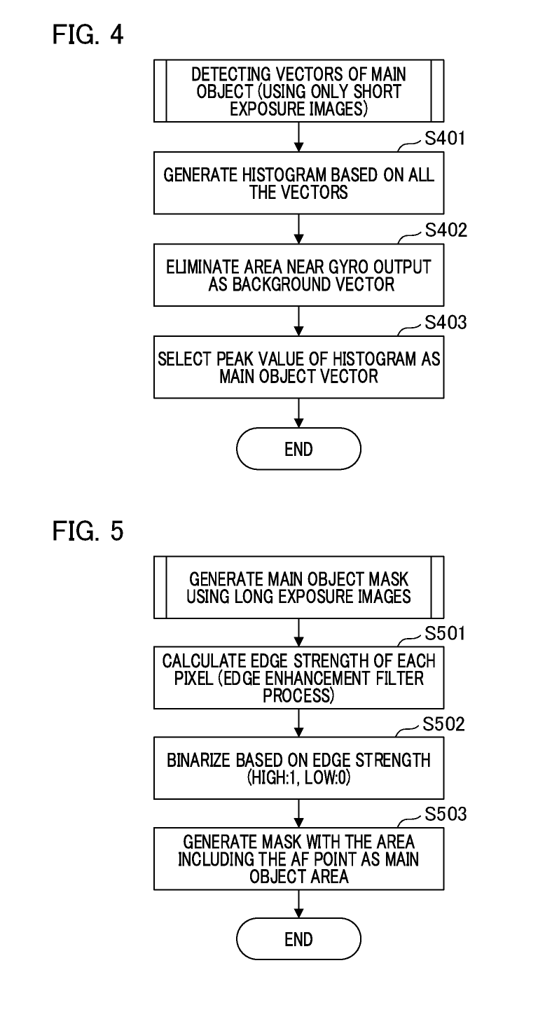

FIG. 4 is a flowchart illustrating detecting the vector of the main object performed in step S312 of FIG. 3. In step S401, the CPU 210 generates a histogram based on all the vector data detected in step S306. Then in step S402, the CPU 210 eliminates vectors of a background from the histogram based on the output of the gyro sensor 112 or the angle velocity sensor 402. To be more specific, the CPU 201 vector-converts the angle velocity output from the gyro sensor 112 or the angle velocity sensor 402 to eliminate the vector in reverse phase as the background vector.

In a step S403, the CPU 201 detects a peak vector from the histogram from which the background vector has been already eliminated and regards the detected peak vector as the vector of the main object. However, as to a way to detect the vector of a main object, the present invention is not limited to the above method. Other methods may be applicable to this embodiment.

Returning to FIG. 3, in step S308, the CPU 201 calculates Tv during a long exposure period. For example, the CPU 201 can obtain the Tv during a long exposure period in formula (1) by setting “a” larger than that set in step S304. Next, in step S309, the CPU 201 obtains the long exposure image based on the Tv calculated in step S308. Since the user is panning the camera at a constant angular velocity equal to or higher than a predetermined level (“YES” in step S301), the image obtained in step S309 is an image in which the background other than the main object is flowing. Then, in step S310, the CPU 201 functions as a second detection unit and detects a main object area. To be more specific, the CPU 201 generates an object mask based on the long exposure images obtained in step S309, wherein the object mask denotes information that indicates the main object area.

FIG. 5 is a flowchart illustrating generating the object mask performed in step S310 of FIG. 3. In step S501, the CPU 201 performs an edge enhancement processing on each pixel of the long exposure image obtained in step S309. In step S501, the CPU 201 also calculates an edge strength of each pixel. As an edge enhancement filter used for the edge enhancement processing, a generally known filter such as Laplacian filter or Sobel filter may be used. Otherwise, a filter suitably designed for the present embodiment or a combination of some of the above filters may be applicable.

In step S502, the CPU 201 binarizes the edge strength of each pixel calculated in step S501. In step S503, the CPU201 generates the object mask with the area including the AF point as the main object area in the binarized image (the strong edge image) in step S 502.

In the present embodiment, although the object mask is produced based on the high edge image through the edge enhancement filter and focused area information, the object mask may be produced based on defocus amount information. Furthermore, the CPU 201 may obtain object information from the long exposure image, detect the object area from the short exposure image using the obtained object information, and set the motion vector corresponding to the detected object area as the main object vector. For example, the CPU 201 may obtain color information of the object as the object information and detect the main object area from the short exposure image based on the obtained color information.

Returning to FIG. 3, in step S311, the CPU 201, functioning as a control unit, determines the vector corresponding to the main object area as the main object vector among the vectors obtained in step S306. To be more specific, the CPU 201 determines the vector within the main object mask (within the main object area) obtained in step S310 as the main object vector. Then, in step S313, the CPU 201 determines whether or not the detection is continued. Unless vector detection is stopped for example by starting an image shooting operation, the process returns to the step S301. If the detection is not continued, the process in FIG. 3 ends. In this connection, the short and long exposure mode is set in step S302, the CPU 201 may control the display unit 108 to display the long exposure images. After the detection of the main object vector as described above, the process using the detected main object vector is performed. The process using the detected main object vector is for example an image stabilizing process, where the CPU 201 controls to move at least one of the image sensor 102 and a lens included in the imaging optical system 101 in a direction perpendicular to an optical axis of the imaging optical system so as to correct the image blur of the object. By using the main object vector detected with high accuracy, it is possible to acquire a captured image in which the movement of the main object is suppressed.

The imaging apparatus according to the present embodiment detects the main abject area using the long exposure image and sets the vector in the main object area as the main object vector from among the vectors obtained from the short exposure image. As a result, the detection of the main object vector is performed with high accuracy.

### Second Embodiment

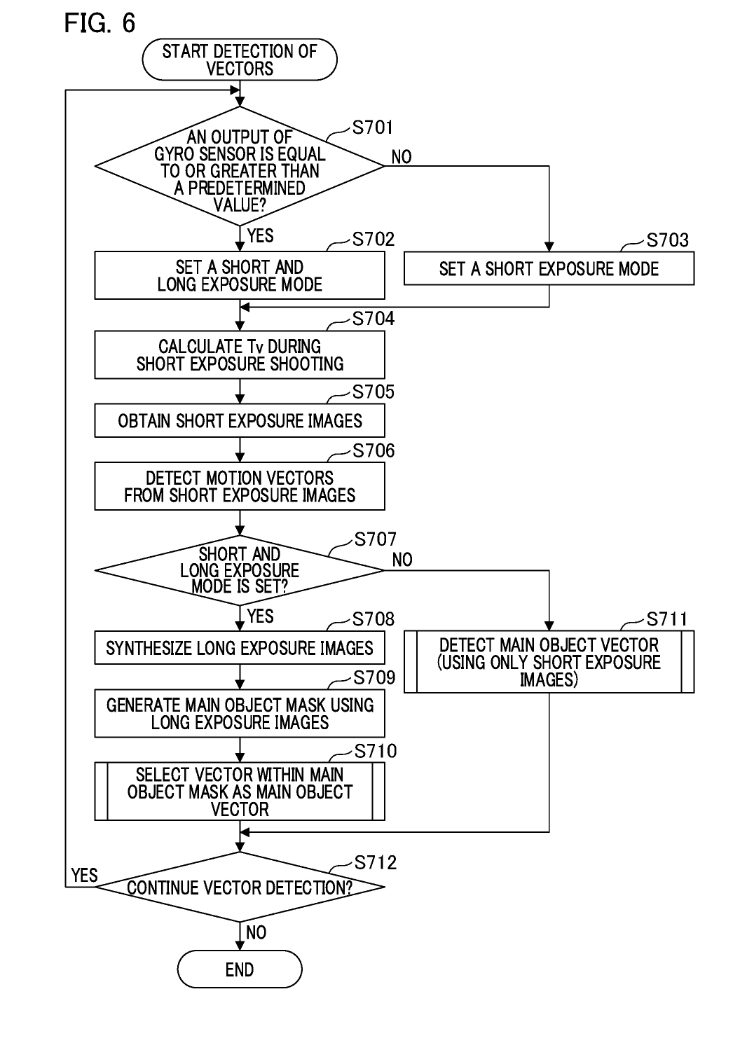

FIG. 6 is a flowchart illustrating detecting the main object vector by an image processing apparatus of a second embodiment. Each of steps S701 to S704 corresponds to the steps S301 to S304 in FIG. 3 and is respectively the same step, explanations for them are omitted. In step S705, the CPU 201 obtains short exposure images based on the Tv set in step S704, and then stores the short exposure images in the primary memory 105. Each of steps S706, S707, and S711 corresponds to the steps S306, S307, and S312 in FIG. 3, and is respectively the same step, and thus, explanations for them are omitted.

In step S707, if the CPU 201 determines that the short and long exposure mode is set, the process proceeds to step S708. In step S708, the CPU 201 reads out the short exposure images stored in the primary memory 105, and generates the image which corresponds to the long exposure image based on the read short exposure image. Similarly to the long exposure image in the first embodiment, the image corresponding to the long exposure is the second image corresponding to the second exposure period which is longer than the first exposure period. In the present embodiment, the CPU 201 synthesizes the long exposure image by taking averaging for each for the short exposure images. In this connection, other synthesizing method may be adopted instead of the method explained in the above embodiment.

Next, in step S709, the CPU 201 generates the main object mask from the image corresponding to the long exposure obtained in step S708. Since the way to generate the main object mask is the same as that in the first embodiment, explanation for it is omitted. In addition, since steps S710 and S712 are respectively the same as the steps S310 and S313, explanation for them is omitted.

The imaging apparatus according to the present embodiment detects the main abject area using the image corresponding to the long exposure obtained by the image synthesis and sets the vector in the main object area as the main object vector from among the vectors obtained from the short exposure image. As a result, the detection of the main object vector is performed with high accuracy. Above, preferable embodiments of the present application have been explained. However, the present invention is not limited to these embodiments. Various modifications are possible within the substance of the scope. In addition, not all of the combinations of features explained in the embodiments are necessary for the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-208405, filed Oct. 27, 2017 which is hereby incorporated by reference wherein in its entirety.

What is claimed is:

1. An image processing apparatus comprising:
at least one processor and at least one memory functioning as:
an obtaining unit configured to obtain a first image corresponding to a first exposure period and a second image corresponding to a second exposure period longer than the first exposure period;
a first detection unit configured to detect a motion vector based on the first image;
a second detection unit configured to detect a main object area based on the second image; and
a control unit configured to determine a motion vector corresponding to the main object area detected by the second detection unit as a motion vector of a main object, among the vectors detected by the first detection unit.

2. The image processing apparatus according to claim 1, wherein the control unit determines the motion vector within the detected main object area as a motion vector of the main object, among vectors detected by the first detection unit.

3. The image processing apparatus according to claim 1, wherein the second detection unit obtains object information from the second image and detects the main object area from the first image based on the object information.

4. The image processing apparatus according to claim 3, wherein the second detection unit obtains color information as the object information and detects the main object area from the first image based on the color information.

5. The image processing apparatus according to claim 1, wherein the obtaining unit obtains the second image by combining a plurality of the first images.

6. The image processing apparatus according to claim 1, wherein the obtaining unit obtains the first image and the second image when an output of a shake detecting signal applied to the image processing apparatus is over a predetermined threshold level.

7. The image processing apparatus according to claim 6, further comprising:
a display unit configured to display the second image when the output of the shake detecting signal is over a predetermined threshold level.

8. The image processing apparatus according to claim 1, wherein the obtaining unit changes the first exposure period depending on an output level of a shake detecting signal applied to the image processing apparatus.

9. The image processing apparatus according to claim 8, wherein the obtaining unit shortens the first exposure period as the output level of the shake detecting signal applied to the image processing apparatus is larger.

10. The image processing apparatus according to claim 1, further comprising:
an image sensor for photoelectrically converting object light imaged through an imaging optical system,
wherein at least one of the image sensor and a lens included in the imaging optical system is moved in a direction perpendicular to an optical axis of the imaging optical system according to the motion vector of the main object determined by the control unit.

11. An image processing apparatus comprising:
at least one processor and at least one memory functioning as:
an obtaining unit configured to obtain a first image corresponding to a first exposure period and a second image corresponding to a second exposure period longer than the first exposure period;
a first detection unit configured to detect a motion vector based on a plurality of the first images;
a second detection unit configured to detect a main object area based on the second image; and
a processing unit configured to process a motion vector corresponding to the main object area as a motion vector of a main object.

12. The image processing apparatus according to claim 11, wherein the processing unit processes the motion vector corresponding to the main object area as the motion vector of the main object, from the motion vectors of the plurality of areas detected by the first detection unit.

13. The image processing apparatus according to claim 11, wherein the second detection unit detects the main object area in the first image based on the main object information in the second image.

14. The image processing apparatus according to claim 13, wherein the main object information includes color information.

15. The image processing apparatus according to claim 11, wherein the obtaining unit obtains the second image by combining the plurality of the first images.

16. The image processing apparatus according to claim 11, wherein the processing unit performs a processing to move an image sensor for photoelectrically converting object light imaged through an imaging optical system in a direction perpendicular to an optical axis of the imaging optical system according to the motion vector of the main object.

17. The image processing apparatus according to claim 11, wherein the processing unit performs a processing to move a lens included in an imaging optical system in a direction perpendicular to an optical axis of the imaging optical system according to the motion vector of the main object.

18. A control method for an image processing apparatus, the control method comprising:
obtaining a first image corresponding to a first exposure period and a second image corresponding to a second exposure period longer than the first exposure period;
detecting a motion vector based on the first image;
detecting a main object area based on the second image; and
determining a motion vector corresponding to the detected main object area as a motion vector of a main object among the detected vectors.
